(19) United States
(12) Patent Application Publication
(10) Pub. No.: US 2026/0346628 A1
(43) Pub. Date: Nov. 5, 2026

(54) ABNORMALITY DETECTION METHOD, LIQUID PASSAGE SYSTEM, AND RECORDING APPARATUS

(71) Applicant: SEIKO EPSON CORPORATION, Tokyo (JP)

(72) Inventors: Shiro NAKAMURA, Matsumoto-shi (JP); Jun SATO, Shiojiri-shi (JP); Shuichi NAKANO, Shiojiri-shi (JP)

(73) Assignee: SEIKO EPSON CORPORATION, Tokyo (JP)

(21) Appl. No.: 19/663,388

(22) Filed: Apr. 30, 2026

(30) Foreign Application Priority Data
May 1, 2025 (JP) 2025-076340

(51) Int. Cl. B41J 29/46; B41J 2/175; B41J 29/393

(52) U.S. Cl. CPC B41J 29/46; B41J 2/17596; B41J 29/393

(57) ABSTRACT

An abnormality detection method in a recording apparatus including a liquid ejection head, a supply flow path through which the liquid flows, a supply pump provided in the supply flow path, a driving motor configured to drive the supply pump, and a measurement section configured to measure a current flowing through the driving motor is provided. The abnormality detection method includes setting, as an activation current value, a maximum value by the measurement section in an activation time region, determining presence or absence of an abnormality of the supply pump depending on whether or not the activation current value is included in a reference range, setting a determination value by performing arithmetic processing in an operation time region after the activation time region, and determining presence or absence of an abnormality in the supply flow path by comparing the activation current value with the determination value.

### CROSS-REFERENCE TO RELATED APPLICATIONS

The present application is based on, and claims priority from JP Application Serial Number 2025-076340, filed May 1, 2025, the disclosure of which is hereby incorporated by reference herein in its entirety.

### BACKGROUND

### 1. Technical Field

The present disclosure relates to an abnormality detection method, a liquid passage system, and a recording apparatus.

### Related Art

There is a recording apparatus that performs recording by ejecting ink, which is an example of a liquid, from a recording head, which is an example of a liquid ejection head, as in JP-A-2007-105935, for example. The recording apparatus includes a driving motor, a supply pump, which is an example of a liquid pump, a current detection circuit, which is an example of a measurement section, and a main control section.

The driving motor drives the supply pump. The supply pump supplies ink stored in an ink cartridge to the recording head. The current detection circuit detects a current flowing when the driving motor is driven. Once a current value detected by the current detection circuit reaches a certain current value, the control section determines that the pressure inside the supply pump is abnormal and stops the driving of the driving motor.

The value of the current flowing through the driving motor varies from individual to individual. Therefore, in a case where the detected current value is compared with a fixed threshold value as in JP-A-2007-105935, there is a concern that abnormality in a liquid flow path cannot be detected.

### SUMMARY

An abnormality detection method that solves the above problem is an abnormality detection method in a recording apparatus including a liquid ejection head configured to perform recording by ejecting a liquid onto a medium, a liquid flow path through which the liquid flows, a liquid pump provided in the liquid flow path, a driving motor configured to drive the liquid pump, and a measurement section configured to measure a current flowing through the driving motor and output a current value. The abnormality detection method includes setting, as an activation current value, a maximum value among a plurality of current values output by the measurement section in an activation time region, determining presence or absence of an abnormality of the liquid pump depending on whether or not the activation current value is included in a reference range, setting a determination value by performing arithmetic processing on a plurality of current values output by the measurement section in an operation time region after the activation time region, and determining presence or absence of an abnormality in the liquid flow path by comparing the activation current value with the determination value.

A liquid passage system that solves the above problem includes a liquid flow path through which a liquid flows, the liquid being supplied to a liquid ejection head configured to perform recording by ejecting the liquid onto a medium or the liquid being discharged from the liquid ejection head, a liquid pump provided in the liquid flow path, a driving motor configured to drive the liquid pump, a measurement section configured to measure a current flowing through the driving motor and output a current value, and a control section. The control section sets, as an activation current value, a maximum value among a plurality of current values output by the measurement section in an activation time region and determines presence or absence of an abnormality of the liquid pump depending on whether or not the activation current value is included in a reference range, and sets a determination value by performing arithmetic processing on a plurality of current values output by the measurement section in an operation time region after the activation time region and determines presence or absence of an abnormality in the liquid flow path by comparing the activation current value with the determination value.

A recording apparatus that solves the above problem includes a liquid ejection head configured to perform recording by ejecting a liquid onto a medium, a liquid flow path through which the liquid flows, a liquid pump provided in the liquid flow path, a driving motor configured to drive the liquid pump, a measurement section configured to measure a current flowing through the driving motor and output a current value, and a control section. The control section sets, as an activation current value, a maximum value among a plurality of current values output by the measurement section in an activation time region and determines presence or absence of an abnormality of the liquid pump depending on whether or not the activation current value is included in a reference range, and sets a determination value by performing arithmetic processing on a plurality of current values output by the measurement section in an operation time region after the activation time region and determines presence or absence of an abnormality in the liquid flow path by comparing the activation current value with the determination value.

An abnormality detection method that solves the above problem is an abnormality detection method in a recording apparatus including a liquid ejection head configured to perform recording by ejecting a liquid onto a medium, a liquid flow path through which the liquid flows, a liquid pump provided in the liquid flow path, a driving motor configured to drive the liquid pump, and a measurement section configured to measure a current flowing through the driving motor and output a current value. The abnormality detection method includes setting, as an activation current value, the current value output by the measurement section at an initial time point, determining presence or absence of an abnormality of the liquid pump depending on whether or not the activation current value is included in a reference range, and determining presence or absence of an abnormality in the liquid flow path by comparing the activation current value with the current value output by the measurement section at a measurement time point later than the initial time point.

### BRIEF DESCRIPTION OF THE DRAWINGS

FIG. 1 is a schematic diagram of a recording apparatus.

FIG. 2 is a graph showing an activation time region and an operation time region.

FIG. 3 is a flowchart showing a first abnormality detection routine.

FIG. 4 is a graph showing an initial time point and a measurement time point.

FIG. 5 is a flowchart showing a second abnormality detection routine.

### DESCRIPTION OF EMBODIMENTS

### Embodiment

Hereinafter, an embodiment of a recording apparatus, a liquid passage system, and an abnormality detection method will be described with reference to the drawings. The recording apparatus is, for example, an ink jet type printer which performs recording by ejecting ink, which is an example of a liquid, onto a medium such as paper, fabric, vinyl, a plastic component, or a metal component.

### Recording Apparatus

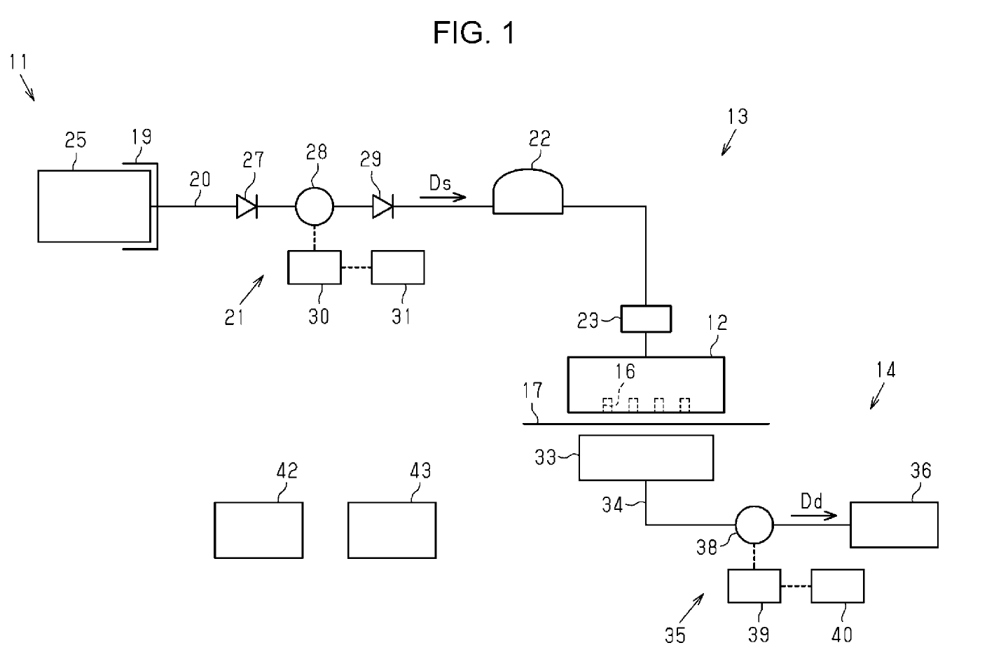

As illustrated in FIG. 1, a recording apparatus 11 may include a liquid ejection head 12, a supply system 13, which is an example of a liquid passage system, and a maintenance system 14, which is an example of a liquid passage system.

The liquid ejection head 12 includes one or more nozzles 16. The liquid ejection head 12 can eject a liquid from the nozzles 16. The liquid ejection head 12 performs recording by ejecting the liquid onto a medium 17.

### Supply System

The supply system 13 may include a mounting section 19, a supply flow path 20, which is an example of a liquid flow path, a first liquid sending section 21, a buffer 22, and a pressure adjustment valve 23.

The supply system 13 supplies the liquid to the liquid ejection head 12. The supply system 13 may supply the liquid from a liquid containing section 25 mounted on the mounting section 19 to the liquid ejection head 12. The liquid flows through the supply flow path 20 in a supply direction Ds.

The liquid containing section 25 may be mounted to be attachable to and detachable from the mounting section 19. The liquid containing section 25 contains the liquid.

An upstream end of the supply flow path 20 in the supply direction Ds is connected to the liquid containing section 25. The upstream end of the supply flow path 20 may be provided at the mounting section 19. The supply flow path 20 can lead out the liquid contained in the liquid containing section 25 by being connected to the liquid containing section 25 mounted on the mounting section 19. A downstream end of the supply flow path 20 in the supply direction Ds is connected to the liquid ejection head 12. The liquid to be supplied to the liquid ejection head 12 flows through the supply flow path 20.

The first liquid sending section 21 sends the liquid in the supply direction Ds. The first liquid sending section 21 pressurizes and supplies the liquid to the liquid ejection head 12. The first liquid sending section 21 may include a first one-way valve 27, a supply pump 28, which is an example of a liquid pump, a second one-way valve 29, a first driving motor 30, which is an example of a driving motor, and a first measurement section 31, which is an example of a measurement section.

The first one-way valve 27 is provided further upstream than the supply pump 28. The second one-way valve 29 is provided further downstream than the supply pump 28. The first one-way valve 27 and the second one-way valve 29 allow the liquid to flow toward the downstream side in the supply direction Ds and restrict flowing of the liquid toward the upstream side.

The supply pump 28 is provided in the supply flow path 20. The supply pump 28 may be provided between the first one-way valve 27 and the second one-way valve 29. The supply pump 28 is, for example, a diaphragm pump.

The first driving motor 30 drives the supply pump 28.

The first measurement section 31 measures a current flowing through the first driving motor 30 and outputs a current value. The first measurement section 31 may indirectly measure the current flowing through the first driving motor 30. For example, the first measurement section 31 may measure a current flowing through an electric circuit connected to the first driving motor 30. The first measurement section 31 may measure a voltage of the electric circuit connected to the first driving motor 30 and also calculate a current value from the measured voltage.

The buffer 22 is provided further downstream than the first liquid sending section 21. The buffer 22 stores the liquid. For example, one surface of the buffer 22 is formed of a flexible film. The buffer 22 has a variable capacity for storing the liquid. The buffer 22 stabilizes the pressure of the liquid flowing through the supply flow path 20.

The pressure adjustment valve 23 stabilizes the pressure of the liquid to be supplied to the nozzles 16 by adjusting the pressure of the liquid supplied under pressure. The pressure adjustment valve 23 may adjust the pressure of the liquid in the liquid ejection head 12 to a pressure at which a meniscus is formed in the nozzles 16. The pressure adjustment valve 23 may open the supply flow path 20 when the pressure on the downstream side is lower than a predetermined pressure.

### Maintenance System

The maintenance system 14 may include a cap 33, a discharge flow path 34, which is an example of a liquid flow path, and a second liquid sending section 35. The maintenance system 14 performs maintenance of the liquid ejection head 12. The maintenance system 14 may cause the nozzles 16 to discharge the liquid by performing suction cleaning. The maintenance system 14 sends the liquid discharged from the liquid ejection head 12 to a waste liquid containing section 36. The waste liquid containing section 36 may be provided to be attachable to and detachable from the recording apparatus 11. The liquid flows through the discharge flow path 34 in a discharge direction Dd.

The cap 33 can form a closed space that covers the nozzles 16 by coming into contact with the liquid ejection head 12. Forming the closed space will also be referred to as capping the liquid ejection head 12.

An upstream end of the discharge flow path 34 in the discharge direction Dd is connected to the cap 33, and a downstream end thereof is connected to the waste liquid containing section 36. The discharge flow path 34 may be formed of, for example, a tube that is deformable in accordance with movement of the cap 33.

The second liquid sending section 35 may include a suction pump 38, which is an example of a liquid pump, a second driving motor 39, which is an example of a driving motor, and a second measurement section 40, which is an example of a measurement section. The second liquid sending section 35 causes the liquid ejection head 12 to discharge the liquid by setting the inside of the cap 33, which caps the liquid ejection head 12, to a negative pressure. The cap 33 can receive the liquid discharged from the nozzles 16. The liquid discharged from the liquid ejection head 12 flows through the discharge flow path 34.

The suction pump 38 is provided in the discharge flow path 34. The suction pump 38 is, for example, a tube pump.

The second driving motor 39 drives the suction pump 38.

The second measurement section 40 measures a current flowing through the second driving motor 39 and outputs a current value. The second measurement section 40 may indirectly measure the current flowing through the second driving motor 39. For example, the second measurement section 40 may measure a current flowing through an electric circuit connected to the second driving motor 39. The second measurement section 40 may measure a voltage of the electric circuit connected to the second driving motor 39 and also calculate a current value from the measured voltage.

The recording apparatus 11 may include a notification section 42. The notification section 42 can notify a user of information, for example. The notification section 42 may notify the user of each of information regarding the supply system 13 and information regarding the maintenance system 14. Therefore, it is also possible to state that each of the supply system 13 and the maintenance system 14 includes the notification section 42.

The notification section 42 may be a monitor that provides notification by displaying images, characters, and the like, or may be a touch panel that enables display and operations. The notification section 42 may be a speaker that provides notification by emitting voice, sound, or the like, or may be a bell. The notification section 42 may be a light that provides notification by light emission, blinking, or the like. The notification section 42 may be a communication section that communicates with an external device such as a smartphone, a personal computer, or a server and causes the external device to provide notification of information.

The recording apparatus 11 includes a control section 43. The control section 43 may control each main operation executed by the recording apparatus 11. The control section 43 integrally controls driving of each mechanism in the supply system 13 and the maintenance system 14. Therefore, it is also possible to state that each of the supply system 13 and the maintenance system 14 includes the control section 43.

The control section 43 can be configured as a circuit including α: one or more processors that execute various processes according to a computer program, β: one or more dedicated hardware circuits that execute at least some of the various processes, or γ: a combination thereof. The hardware circuit is, for example, an application-specific integrated circuit. The processor includes a CPU and a memory such as a RAM and a ROM, and the memory stores program codes or instructions configured to cause the CPU to execute the processes. The memory, that is, a computer-readable medium includes any readable medium accessible by a general-purpose or dedicated computer.

### First Abnormality Detection Method

One or both of the supply system 13 and the maintenance system 14 may execute a first abnormality detection method, which is an example of an abnormality detection method. The first abnormality detection methods of the supply system 13 and the maintenance system 14 are substantially the same. In other words, if the supply flow path 20, the supply pump 28, the first driving motor 30, and the first measurement section 31 are replaced with the discharge flow path 34, the suction pump 38, the second driving motor 39, and the second measurement section 40, then the first abnormality detection method for the supply system 13 becomes the first abnormality detection method for the maintenance system 14. Therefore, the first abnormality detection method executed by the supply system 13 will be described in the present embodiment, and description of the first abnormality detection method executed by the maintenance system 14 will be omitted.

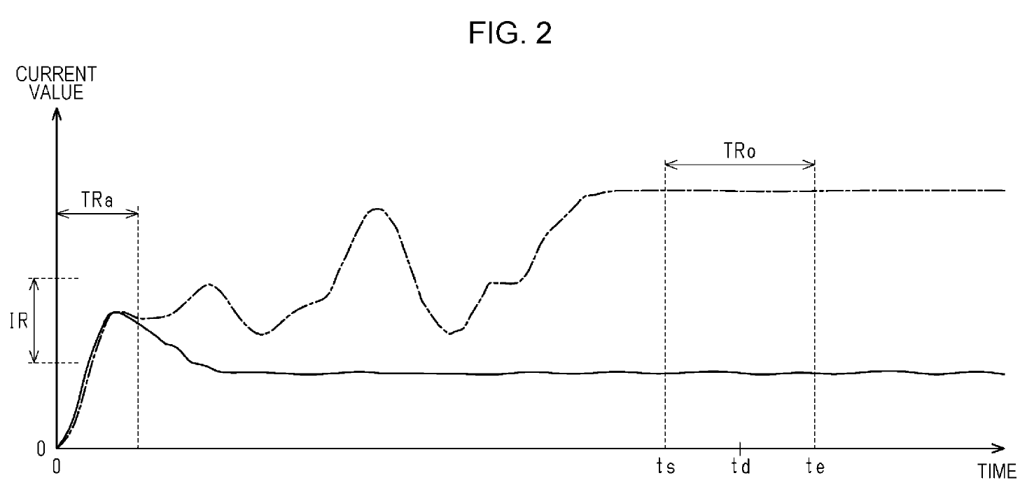

FIG. 2 is a graph showing a change in the current value measured by the first measurement section 31 when the time at which the supply pump 28 is activated is defined as 0. The solid line is an example of a current value measured in a state where the liquid can normally flow through the supply flow path 20. The one-dotted chain line is an example of a current value measured in a state where an abnormality occurs in the supply flow path 20 due to the supply flow path 20 being bent or blocked.

An activation time region TRa, a reference range IR, and a determination time point td may be stored in the control section 43 in advance. The activation time region TRa, the reference range IR, and the determination time point td may be set in advance based on a current value measured in a state where the supply pump 28 and the supply flow path 20 are normal.

The activation time region TRa is a time region immediately after activation of the supply pump 28, and is a time region in which an inrush current equal to or greater than a rated current may flow. The reference range IR is a range set to include the maximum value of the inrush current. The determination time point td is a time point after the pressure of the supply flow path 20 is stabilized. The determination time point td may be set to a time point after the buffer 22 is filled with the liquid.

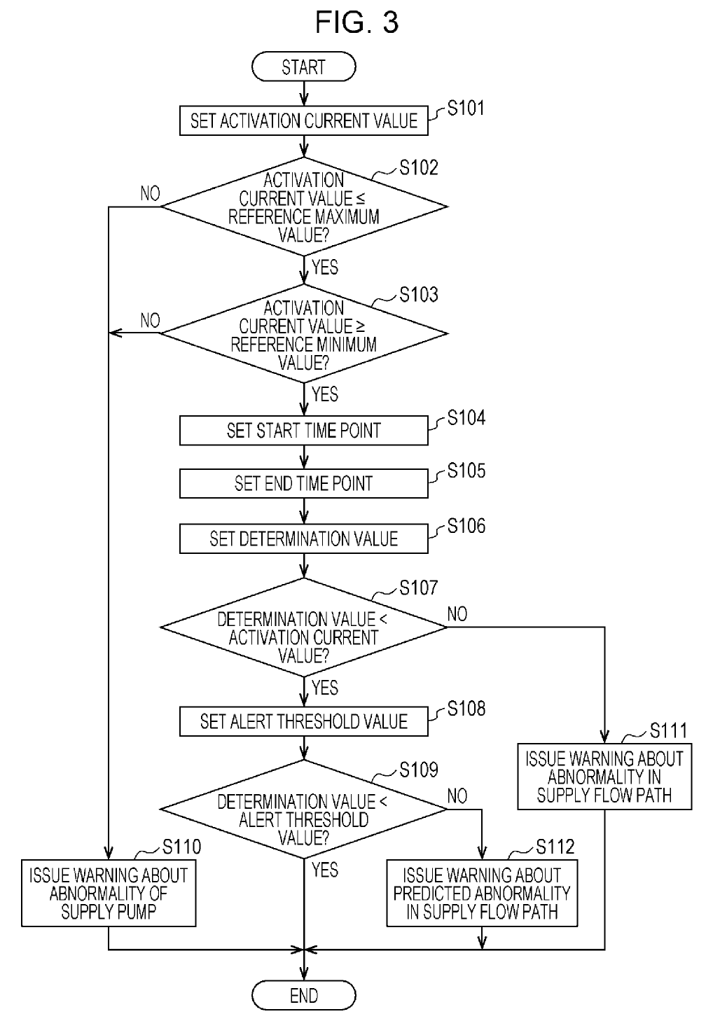

As shown in FIG. 3, the control section 43 executes a first abnormality detection routine. For example, the control section 43 may execute the first abnormality detection routine on the supply system 13 in association with an initialization process after the recording apparatus 11 is activated. The control section 43 may execute the first abnormality detection routine on the supply system 13 before recording is performed on the medium 17.

In Step S101, the control section 43 sets an activation current value. The control section 43 sets, as the activation current value, the maximum value among a plurality of current values output by the first measurement section 31 in the activation time region TRa.

In Step S102 and Step S103, the control section 43 determines whether or not the activation current value is included in the reference range IR. In a case where the activation current value is included in the reference range IR, the control section 43 moves on to a process in Step S104. In other words, in Step S102, the control section 43 compares a reference maximum value, which is the maximum value in the reference range IR, with the activation current value. In a case where the activation current value is equal to or less than the reference maximum value, YES determination is made in Step S102, and the control section 43 moves on to a process in Step S103. In Step S103, the control section 43 compares a reference minimum value, which is a minimum value in the reference range IR, with the activation current value. In a case where the activation current value is equal to or greater than the reference minimum value, YES determination is made in Step S103, and the control section 43 moves on to a process in Step S104.

In Step S104, the control section 43 sets a start time point ts of an operation time region TRo shown in FIG. 2 to be earlier than the determination time point td. The control section 43 sets the start time point ts to be later than the activation time region TRa. The operation time region TRo is a time region later than the activation time region TRa. The operation time region TRo is a time region in which the current flowing through the first driving motor 30 is stable.

In Step S105, the control section 43 sets an end time point te of the operation time region TRo shown in FIG. 2 to be later than the determination time point td by a time difference between the determination time point td and the start time point ts. In other words, the control section 43 sets the operation time region TRo such that the determination time point td is located at the center.

In Step S106, the control section 43 sets a determination value by performing arithmetic processing on a plurality of current values output by the first measurement section 31 in the operation time region TRo. The control section 43 may set the determination value by averaging the plurality of current values output by the first measurement section 31 in the operation time region TRo.

In Step S107, the control section 43 compares the activation current value with the determination value. In a case where the determination value is less than the activation current value, YES determination is made in Step S107, and the control section 43 moves on to a process in Step S108.

In Step S108, the control section 43 sets an alert threshold value. The control section 43 may set the alert threshold value by multiplying the activation current value by an alert ratio. The alert threshold value is a value that is less than the activation current value.

In Step S109, the control section 43 compares the determination value with the alert threshold value. In a case where the determination value is less than the alert threshold value, YES determination is made in Step S109, and the control section 43 ends the process.

In a case where the activation current value is not included in the reference range IR in Step S102 and Step S103, the control section 43 moves on to a process in Step S110. In other words, in a case where the activation current value is greater than the reference maximum value, NO determination is made in Step S102, and the control section 43 moves on to a process in Step S110. In a case where the activation current value is less than the reference minimum value, NO determination is made in Step S103, and the control section 43 moves on to the process in Step S110. In Step S110, the control section 43 determines that an abnormality has occurred in the supply pump 28, issues a warning, and ends the process.

In a case where the determination value is equal to or greater than the activation current value in Step S107, NO determination is made in Step S107, and the control section 43 moves on to a process in Step S111. In Step S111, the control section 43 determines that an abnormality has occurred in the supply flow path 20, issues a warning, and ends the process.

In a case where the determination value is equal to or greater than the alert threshold value in Step S109, NO determination is made in Step S109, and the control section 43 moves on to a process in Step S112. In Step S112, the control section 43 determines that an abnormality in the supply flow path 20 is predicted, issues a warning, and ends the process.

### Second Abnormality Detection Method

One or both of the supply system 13 and the maintenance system 14 may execute a second abnormality detection method, which is an example of an abnormality detection method. The second abnormality detection methods of the supply system 13 and the maintenance system 14 are substantially the same. The second abnormality detection method executed by the maintenance system 14 will be described in the present embodiment, and description of the second abnormality detection method executed by the supply system 13 will be omitted. If the discharge flow path 34, the suction pump 38, the second driving motor 39, and the second measurement section 40 are replaced with the supply flow path 20, the supply pump 28, the first driving motor 30, and the first measurement section 31, then the second abnormality detection method for the maintenance system 14 becomes the second abnormality detection method for the supply system 13.

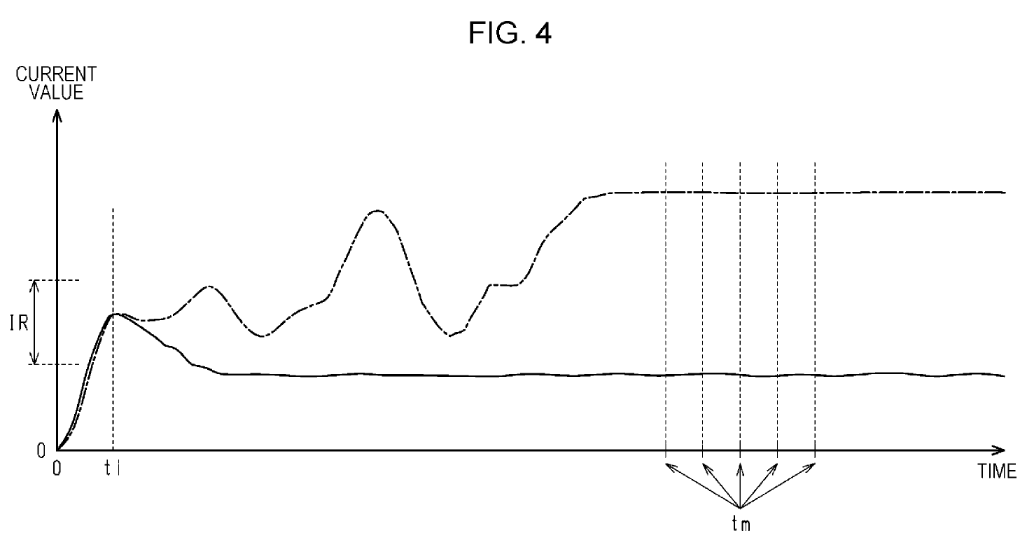

FIG. 4 is a graph showing a change in the current value measured by the second measurement section 40 when the time at which the suction pump 38 is activated is defined as 0. The solid line is an example of a current value measured in a state where the liquid discharged from the nozzles 16 by the suction cleaning, for example, is normally sent to the waste liquid containing section 36. The one-dotted chain line is an example of a current value measured in a state where an abnormality occurs in the liquid sending of the discharge flow path 34 due to the discharge flow path 34 being bent or blocked.

An initial time point ti, a reference range IR, and one or more measurement time points tm may be stored in advance in the control section 43. The initial time point ti, the reference range IR, and the one or more measurement time points tm may be set in advance based on a current value measured in a state where the suction pump 38 and the discharge flow path 34 are normal.

The initial time point ti may be a time point at which the maximum value of the inrush current is measured, or may be a time point at which the inrush current is predicted to be maximized.

The reference range IR is a range set to include the maximum value of the inrush current. The reference range IR of the suction pump 38 may be the same as or different from the reference range IR of the supply pump 28.

The measurement time point tm is a time point later than the initial time point ti. The measurement time point tm is a time point set after the pressure of the discharge flow path 34 is stabilized. A plurality of measurement time points tm may be set at the same time intervals. The intervals between the plurality of measurement time points tm may be driving intervals of the suction pump 38. In a case where the suction pump 38 is a tube pump in which, for example, a plurality of rollers move while crushing a tube constituting the discharge flow path 34 to send the liquid, a time point at which each roller starts to crush the tube may be set as the measurement time point tm.

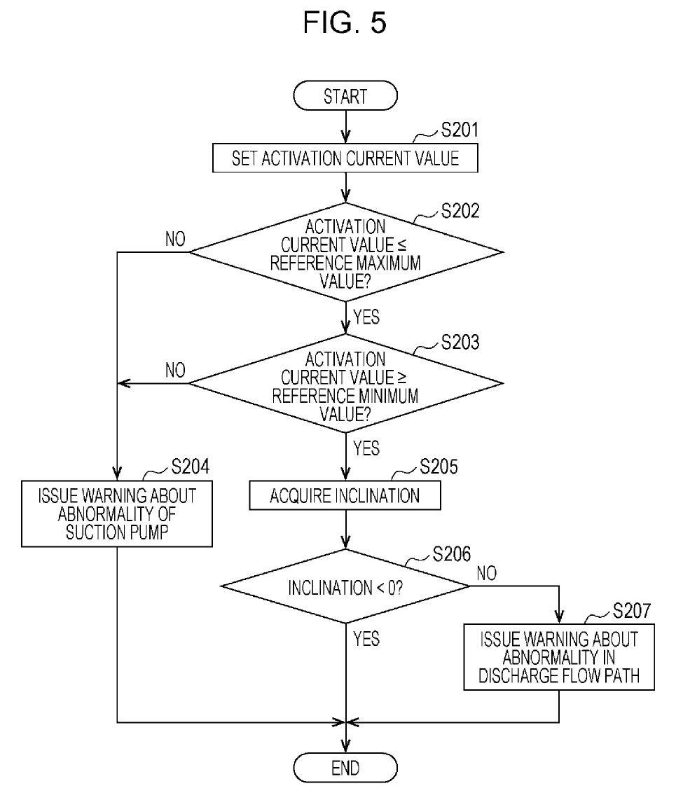

As shown in FIG. 5, the control section 43 may cause the maintenance system 14 to execute the second abnormality detection routine when the suction cleaning is performed, for example.

In Step S201, the control section 43 sets an activation current value. The control section 43 sets, as the activation current value, the current value output by the second measurement section 40 at the initial time point ti.

In Step S202 and Step S203, the control section 43 determines whether or not the activation current value is included in the reference range IR. In Step S202, the control section 43 compares a reference maximum value, which is the maximum value in the reference range IR, with the activation current value. In Step S203, the control section 43 compares a reference minimum value, which is the minimum value in the reference range IR, with the activation current value.

In a case where the activation current value is not included in the reference range IR in Step S202 and Step S203, the control section 43 moves on to a process in Step S204. In other words, in a case where the activation current value is greater than the reference maximum value, NO determination is made in Step S202, and the control section 43 moves on to the process in Step S204. In a case where the activation current value is less than the reference minimum value, NO determination is made in Step S203, and the control section 43 moves on to the process in Step S204. In Step S204, the control section 43 determines that an abnormality has occurred in the suction pump 38, issues a warning, and ends the process.

In a case where the activation current value is included in the reference range IR, the control section 43 moves on to a process in Step S205. In other words, in a case where the activation current value is equal to or less than the reference maximum value, YES determination is made in Step S202, and the control section 43 moves on to a process in Step S203. In a case where the activation current value is equal to or greater than the reference minimum value, YES determination is made in Step S203, and the control section 43 moves on to the process in Step S205.

In Step S205, the control section 43 may obtain an inclination of a linear function using the initial time point ti and the activation current value, and the measurement time point tm and the current value at the measurement time point tm.

For example, the control section 43 may obtain the determination value by averaging a plurality of current values output by the second measurement section 40 at a plurality of measurement time points tm. The control section 43 may obtain the inclination of the linear function by comparing the determination value with the activation current value. For example, the linear function may be an expression of a straight line passing through the initial time point ti and the activation current value, and one measurement time point tm and the determination value. The one measurement time point tm may be a measurement time point tm located at the center of a time series among the plurality of measurement time points tm.

The linear function may be an expression obtained by applying a least squares method to the initial time point ti and the activation current value, and the plurality of measurement time points tm and the current values measured at the respective measurement time points tm. In a case where the least squares method is used, an abnormality in the discharge flow path 34 is more likely to appear in the inclination. Therefore, it is possible to increase accuracy in determining presence or absence of an abnormality even in a case where a change in the current value when an abnormality occurs in the discharge flow path 34 is small.

In Step S206, the control section 43 determines whether or not the inclination of the linear function is less than 0. In a case where the inclination is less than 0, YES determination is made in Step S206, and the control section 43 ends the process. In other words, in a case where the determination value is less than the activation current value, the control section 43 ends the process.

In a case where the inclination is equal to or greater than 0, NO determination is made in Step S206, and the control section 43 moves on to a process in Step S207. In Step S207, the control section 43 determines that an abnormality has occurred in the discharge flow path 34, issues a warning, and ends the process.

### Operation of Present Embodiment

Operation of the present embodiment will be described.

The control section 43 determines presence or absence of an abnormality in the supply pump 28 or the suction pump 38 depending on whether or not the activation current value is included in the reference range IR.

The control section 43 determines presence or absence of an abnormality in the supply flow path 20 by comparing the activation current value with the determination value. The control section 43 may predict an abnormality in the supply flow path 20 by comparing the determination value of the supply system 13 with the alert threshold value. The control section 43 may determine that the supply flow path 20 is normal in a case where the determination value is less than the alert threshold value. The control section 43 may determine that an abnormality in the supply flow path 20 is predicted in a case where the determination value is equal to or greater than the alert threshold value and the determination value is less than the activation current value. The state where an abnormality is predicted is, for example, a state where passage of the liquid in the supply flow path 20 is deteriorated, and a state where the possibility that the supply flow path 20 will be blocked in the near future is increased. The control section 43 may determine that an abnormality has occurred in the supply flow path 20 in a case where the determination value is equal to or greater than the activation current value.

The control section 43 determines presence or absence of an abnormality in the discharge flow path 34 by comparing the activation current value with the current value at the measurement time point tm. The control section 43 may determine the presence or absence of an abnormality in the discharge flow path 34 by comparing a determination value obtained by averaging the current values at the plurality of measurement time points tm with the activation current value. The control section 43 may determine that an abnormality has occurred in the discharge flow path 34 in a case where the determination value is equal to or greater than the activation current value. The control section 43 may determine that the discharge flow path 34 is normal in a case where the determination value is less than the activation current value.

The control section 43 may obtain the inclination of the linear function using the initial time point ti and the activation current value, and one or more measurement time points tm and the current values at the measurement time points tm. The control section 43 may determine that the discharge flow path 34 is normal in a case where the obtained inclination is less than 0. The control section 43 may determine that there is an abnormality in the discharge flow path 34 in a case where the obtained inclination is equal to or greater than 0.

The control section 43 may cause the notification section 42 to issue a warning in a case where it is determined that an abnormality has occurred. The control section 43 may stop driving of the supply pump 28 and the suction pump 38 in a case where it is determined that an abnormality has occurred. The control section 43 may cause the notification section 42 to issue a warning in a case where it is determined that an abnormality is predicted.

### Effects of Present Embodiment

Effects of the present embodiment will be described.

(1-1) Features appear in the current flowing through the first driving motor 30 not only in a case where there is an abnormality in the supply flow path 20 but also in a case where there is an abnormality in the supply pump 28. In this regard, the abnormality of the supply pump 28 can be found by comparing the activation current value with the reference range IR. The abnormality determination for the supply flow path 20 is performed by comparing the activation current value with the determination value. The determination value is a value obtained by performing arithmetic processing on a plurality of current values in the operation time region TRo. In other words, since the determination value is set in accordance with the individual difference of the supply pump 28, it is possible to detect the abnormality by reducing an influence of the individual difference of the supply pump 28.

(1-2) The determination value is an average value of a plurality of current values in the operation time region TRo. Therefore, an influence of noise can be reduced as compared with a case where, for example, one current value is set as the determination value.

(1-3) An abnormality in the supply flow path 20 is predicted by comparing the activation current value with the alert threshold value. It is possible to prepare for occurrence of the abnormality in the supply flow path 20 by predicting the abnormality of the supply flow path 20.

(1-4) A warning is issued in a case where the determination value is equal to or greater than a warning threshold value. Specifically, in a case where the determination value is equal to or greater than the warning threshold value and is less than the activation current value, a warning that an abnormality in the supply flow path 20 is predicted is issued. In a case where the determination value is equal to or greater than the activation current value, a warning that an abnormality has occurred in the supply flow path 20 is issued. Therefore, it is possible to provide a notification of the state of the supply flow path 20.

(1-5) The operation time region TRo has an equivalent time width before and after the determination time point td. Therefore, it is possible to reduce variations in the current value measured in the operation time region TRo. Therefore, it is possible to increase accuracy of the determination value determined from the current value measured in the operation time region TRo.

(1-6) It is possible to find an abnormality of the suction pump 38 by comparing the activation current value with the reference range IR. The abnormality determination for the discharge flow path 34 is performed by comparing the activation current value, which is the current value at the initial time point ti, with the current value at the measurement time point tm. Since the activation current value and the current value at the measurement time point tm change due to the individual difference of the suction pump 38, it is possible to detect the abnormality by reducing the influence of the individual difference of the suction pump 38.

(1-7) The inclination of the linear function is obtained using the initial time point ti and the activation current value, and the measurement time point tm and the current value at the measurement time point tm, and presence or absence of an abnormality in the discharge flow path 34 is determined in accordance with the obtained inclination. Therefore, it is possible to determine the presence or absence of an abnormality in the discharge flow path 34 even in a case where a change in current value when an abnormality has occurred in the discharge flow path 34 is small, for example.

(1-8) The determination value is an average value of a plurality of current values output at a plurality of measurement time points tm. Therefore, an influence of noise can be reduced as compared with a case where, for example, one current value is set as the determination value.

(1-9) The current flowing through the second driving motor 39 may change in accordance with driving intervals of the suction pump 38. In this regard, the intervals of the plurality of measurement time points tm are the driving intervals of the suction pump 38. Therefore, variations in measured current values can be reduced.

### Modification Examples

The present embodiment can be modified and implemented as follows. The present embodiment and the following modification examples can be implemented in combination with each other in a technically consistent range.

The supply system 13 and the maintenance system 14 may execute the first abnormality detection method. The supply system 13 and the maintenance system 14 may execute the second abnormality detection method. The supply system 13 may execute the second abnormality detection method, and the maintenance system 14 may execute the first abnormality detection method. For example, the control section 43 may set the current value output by the first measurement section 31 at the initial time point ti as the activation current value. The control section 43 may set the determination value by averaging a plurality of current values output by the first measurement section 31 at a plurality of measurement time points tm. The control section 43 may determine the presence or absence of an abnormality in the supply flow path 20 depending on whether or not the inclination of a linear function through which the initial time point ti and the activation current value, and the measurement time point tm and the determination value pass is equal to or greater than 0. For example, the control section 43 may set, as the activation current value, the maximum value among a plurality of current values output by the second measurement section 40 in the activation time region TRa. The control section 43 may set the determination value by averaging a plurality of current values output by the second measurement section 40 in the operation time region TRo. The control section 43 may determine the presence or absence of an abnormality in the discharge flow path 34 depending on whether or not the determination value is equal to or greater than the activation current value.

The control section 43 may store an inclination alert value. The inclination alert value is a value that is smaller than 0 and is closer to 0 than the inclination in the normal state. The control section 43 may predict abnormalities in the supply flow path 20 and the discharge flow path 34 by comparing the obtained inclination of the linear function with the inclination alert value. In other words, it may be determined that the abnormality in the supply flow path 20 or the discharge flow path 34 is predicted in a case where the inclination is less than 0 and is equal to or greater than the inclination alert value. The control section 43 may determine that the supply flow path 20 or the discharge flow path 34 is normal in a case where the obtained inclination is less than the inclination alert value.

The time intervals of the plurality of measurement time points tm are not limited to equal intervals and may vary.

The control section 43 may store the operation time region TRo in advance. The control section 43 may set the determination time point td at, for example, the center of the operation time region TRo.

The operation time region TRo may be a region immediately after the activation time region TRa. The operation time region TRo may include an unstable region that is a time region in which the current value is not stable. The operation time region TRo may include a stable region which is a time region after the current value is stabilized. In a case where the operation time region TRo includes the unstable region, the time of the stable region is preferably longer than the time of the unstable region.

The determination time point td may be a time point shifted from the center of the operation time region TRo.

The control section 43 does not necessarily set the alert threshold value. The control section 43 does not necessarily predict an abnormality in the supply flow path 20.

The control section 43 may set, as the determination value, one current value output by the first measurement section 31 or the second measurement section 40 in the operation time region TRo. The control section 43 may set, as the determination value, one of a plurality of current values output by the first measurement section 31 or the second measurement section 40 in the operation time region TRo.

The liquid may be a color ink containing a coloring agent or a protective liquid for protecting an image formed by the ink. The liquid may be, for example, a moisturizing liquid that moisturizes the cap 33. The liquid may be a wiping liquid for wetting a wiper which is for wiping the liquid ejection head 12 and is not illustrated. The liquid may be a cleaning liquid for cleaning a liquid wiper or the like. A liquid supply system may supply the moisturizing liquid to the cap 33. The liquid supply system may supply the wiping liquid or the cleaning liquid to the wiper.

The recording apparatus 11 may be a liquid ejecting apparatus that performs recording by ejecting or discharging a liquid other than ink. States of the liquid which is discharged as a minute amount of liquid droplets from the liquid ejecting apparatus include a granular-shaped state, a tear-shaped state, and a thread-like-tail-shaped state. The liquid described herein is at least a material which can be ejected from the liquid ejecting apparatus. For example, the liquid may be a substance in a state of a liquid phase, and includes liquid materials having a high or low viscosity and fluid materials such as a sol, gel water, other inorganic solvents, organic solvents, a solution, a liquid resin, a liquid metal, and a metal melt. The liquid includes not only a liquid as one state of the substance but also a liquid in which particles of a functional material made of a solid material such as a pigment or a metal particle are dissolved, dispersed, or mixed in a solvent. Representative examples of the liquid include an ink and a liquid crystal as described in the embodiment described above. Here, examples of the ink include various types of liquid compositions, such as a general water-based ink, an oil-based ink, a gel ink, and a hot melt ink. As a specific example of the liquid ejecting apparatus, there is an apparatus which ejects a liquid containing a material such as an electrode material or a color material which is used for manufacturing, for example, a liquid crystal display, an electroluminescence display, a surface emitting display, a color filter, or the like in a dispersed or dissolved form. The liquid ejecting apparatus may be an apparatus that ejects a bioorganic substance to be used for manufacturing a biochip, an apparatus that is used as a precision pipette and ejects a liquid serving as a sample, a textile printing apparatus, a micro dispenser, or the like. The liquid ejecting apparatus may be an apparatus that ejects a lubricating oil exactly to a precision machine such as a watch or a camera, or an apparatus that ejects a transparent resin liquid such as an ultraviolet curable resin onto a substrate in order to form a micro hemispherical lens, an optical lens, or the like to be used in an optical communication element or the like. The liquid ejecting apparatus may be an apparatus that ejects an etchant such as an acid or an alkali for etching a substrate or the like.

### Definitions

As used in the present specification, the phrase "at least one" means "one or more" of desired options. As an example, the phrase "at least one" as used in the present specification means "only one option" or "both of two options" when the number of options is two. As another example, as used herein, the phrase "at least one" means "only one option", "a combination of any two options", or "a combination of any three or more options" if the number of options is three or more.

### Supplementary Notes

Hereinafter, the technical ideas and the functions and effects understood from the above-described embodiment and modification examples will be described.

[1] An abnormality detection method is an abnormality detection method in a recording apparatus including a liquid ejection head configured to perform recording by ejecting a liquid onto a medium, a liquid flow path through which the liquid flows, a liquid pump provided in the liquid flow path, a driving motor configured to drive the liquid pump, and a measurement section configured to measure a current flowing through the driving motor and output a current value. The abnormality detection method includes setting, as an activation current value, a maximum value among a plurality of current values output by the measurement section in an activation time region, determining presence or absence of an abnormality of the liquid pump depending on whether or not the activation current value is included in a reference range, setting a determination value by performing arithmetic processing on a plurality of current values output by the measurement section in an operation time region after the activation time region, and determining presence or absence of an abnormality in the liquid flow path by comparing the activation current value with the determination value.

Features appear in the current flowing through the driving motor not only in a case where there is an abnormality in the liquid flow path but also in a case where there is an abnormality in the liquid pump. In this regard, according to this method, an abnormality of the liquid pump can be found by comparing the activation current value with the reference range. The abnormality determination for the liquid flow path is performed by comparing the activation current value with the determination value. The determination value is a value obtained by performing arithmetic processing on the plurality of current values in the operation time region. In other words, since the determination value is set in accordance with the individual difference of the liquid pump, it is possible to detect the abnormality while reducing an influence of the individual difference of the liquid pump.

[2] In the abnormality detection method according to [1] above, the operation time region may be a time region in which the current flowing through the driving motor is stable, and the determination value may be set by averaging the plurality of current values output by the measurement section in the operation time region.

According to this method, the determination value is an average value of a plurality of current values in the operation time region. Therefore, an influence of noise can be reduced as compared with a case where, for example, one current value is set as the determination value.

[3] The abnormality detection method according to [1] or [2] above may include setting an alert threshold value by multiplying the activation current value by an alert ratio, and predicting an abnormality in the liquid flow path by comparing the determination value with the alert threshold value.

According to this method, an abnormality in the liquid flow path is predicted by comparing the activation current value with the alert threshold value. It is possible to prepare for occurrence of the abnormality in the liquid flow path by predicting the abnormality in the liquid flow path.

[4] The abnormality detection method according to [3] above may include determining that the liquid flow path is normal in a case where the determination value is less than the alert threshold value, determining that an abnormality is predicted in the liquid flow path and issuing a warning in a case where the determination value is equal to or greater than the alert threshold value and the determination value is less than the activation current value, and determining that an abnormality has occurred in the liquid flow path and issuing a warning in a case where the determination value is equal to or greater than the activation current value.

According to this method, a warning is issued in a case where the determination value is equal to or greater than the warning threshold value. Specifically, a warning that an abnormality in the liquid flow path is predicted is issued in a case where the determination value is equal to or greater than the warning threshold value and is less than the activation current value. In a case where the determination value is equal to or greater than the activation current value, a warning that an abnormality has occurred in the liquid flow path is issued. Therefore, it is possible to provide a notification of the state of the liquid flow path.

[5] In the abnormality detection method according to any one of [1] to [4] above, a determination time point may be a time point after a pressure of the liquid flow path is stabilized, and the abnormality detection method may further include setting a start time point of the operation time region before the determination time point, and setting an end time point of the operation time region to be later than the determination time point by a time difference between the determination time point and the start time point.

According to this method, the operation time region has the same time width before and after the determination time point. Therefore, it is possible to reduce variations in current value measured in the calculation time region. Therefore, it is possible to increase accuracy of the determination value determined from the current value measured in the calculation time region.

[6] A liquid passage system includes a liquid flow path through which a liquid flows, the liquid being supplied to a liquid ejection head configured to perform recording by ejecting the liquid onto a medium, or the liquid being discharged from the liquid ejection head, a liquid pump provided in the liquid flow path, a driving motor configured to drive the liquid pump, a measurement section configured to measure a current flowing through the driving motor and output a current value, and a control section. The control section sets, as an activation current value, a maximum value among a plurality of current values output by the measurement section in an activation time region and determines presence or absence of an abnormality of the liquid pump depending on whether or not the activation current value is included in a reference range, and sets a determination value by performing arithmetic processing on a plurality of current values output by the measurement section in an operation time region after the activation time region and determines presence or absence of an abnormality in the liquid flow path by comparing the activation current value with the determination value. According to this configuration, it is possible to achieve effects similar to those of the above-described abnormality detection method.

[7] A recording apparatus includes a liquid ejection head configured to perform recording by ejecting a liquid onto a medium, a liquid flow path through which the liquid flows, a liquid pump provided in the liquid flow path, a driving motor configured to drive the liquid pump, a measurement section configured to measure a current flowing through the driving motor and output a current value, and a control section. The control section sets, as an activation current value, a maximum value among a plurality of current values output by the measurement section in an activation time region and determines presence or absence of an abnormality of the liquid pump depending on whether or not the activation current value is included in a reference range, and sets a determination value by performing arithmetic processing on a plurality of current values output by the measurement section in an operation time region after the activation time region and determines presence or absence of an abnormality in the liquid flow path by comparing the activation current value with the determination value. According to this configuration, it is possible to achieve effects similar to those of the above-described abnormality detection method.

[8] An abnormality detection method is an abnormality detection method in a recording apparatus including a liquid ejection head configured to perform recording by ejecting a liquid onto a medium, a liquid flow path through which the liquid flows, a liquid pump provided in the liquid flow path, a driving motor configured to drive the liquid pump, and a measurement section configured to measure a current flowing through the driving motor and output a current value. The abnormality detection method includes setting, as an activation current value, the current value output by the measurement section at an initial time point, determining presence or absence of an abnormality of the liquid pump depending on whether or not the activation current value is included in a reference range, and determining presence or absence of an abnormality in the liquid flow path by comparing the activation current value with the current value output by the measurement section at a measurement time point later than the initial time point.

According to this method, an abnormality of the liquid pump can be found by comparing the activation current value with the reference range. The abnormality determination for the liquid flow path is performed by comparing the activation current value, which is the current value at the initial time point, with the current value at the measurement time point. Since the activation current value and the current value at the measurement time point change due to the individual difference of the liquid pump, it is possible to detect the abnormality by reducing an influence of the individual difference of the liquid pump.

[9] In the abnormality detection method according to [8] above, an inclination of a linear function may be obtained using the initial time point and the activation current value, and the measurement time point and the current value output by the measurement section at the measurement time point, the liquid flow path may be determined to be normal in a case where the inclination is less than 0, and the liquid flow path may be determined to be abnormal in a case where the inclination is equal to or greater than 0.

According to this method, the inclination of the linear function is obtained using the initial time point and the activation current value, and the measurement time point and the current value at the measurement time point, and the presence or absence of an abnormality in the liquid flow path is determined in accordance with the obtained inclination. Therefore, it is possible to determine the presence or absence of an abnormality in the liquid flow path even in a case where a change in current value when the abnormality occurs in the liquid flow path is small, for example.

In the abnormality detection method according to [8] or [9] above, the presence or the absence of the abnormality in the liquid flow path may be determined by comparing a determination value obtained by averaging a plurality of current values output by the measurement section at a plurality of measurement time points with the activation current value.

According to this method, the determination value is an average value of the plurality of current values output at the plurality of measurement time points. Therefore, an influence of noise can be reduced as compared with a case where, for example, one current value is set as the determination value.

In the abnormality detection method according to above, intervals of the plurality of measurement time points may be driving intervals of the liquid pump.

The current flowing through the driving motor may change in accordance with the driving intervals of the liquid pump. In this regard, according to this method, the intervals of the plurality of measurement time points are the driving intervals of the liquid pump. Therefore, variations in measured current values can be reduced.

What is claimed is:

1. An abnormality detection method in a recording apparatus including
a liquid ejection head configured to perform recording by ejecting a liquid onto a medium,
a liquid flow path through which the liquid flows,
a liquid pump provided in the liquid flow path,
a driving motor configured to drive the liquid pump, and
a measurement section configured to measure a current flowing through the driving motor and output a current value,
the abnormality detection method comprising:
setting, as an activation current value, a maximum value among a plurality of current values output by the measurement section in an activation time region;
determining presence or absence of an abnormality of the liquid pump depending on whether or not the activation current value is included in a reference range;
setting a determination value by performing arithmetic processing on a plurality of current values output by the measurement section in an operation time region after the activation time region; and
determining presence or absence of an abnormality in the liquid flow path by comparing the activation current value with the determination value.

2. The abnormality detection method according to claim 1, wherein
the operation time region is a time region in which the current flowing through the driving motor is stable, and
the determination value is set by averaging the plurality of current values output by the measurement section in the operation time region.

3. The abnormality detection method according to claim 2, further comprising:
setting an alert threshold value by multiplying the activation current value by an alert ratio; and
predicting an abnormality in the liquid flow path by comparing the determination value with the alert threshold value.

4. The abnormality detection method according to claim 3, further comprising:
determining that the liquid flow path is normal in a case where the determination value is less than the alert threshold value;
determining that an abnormality is predicted in the liquid flow path and issuing a warning in a case where the determination value is equal to or greater than the alert threshold value and the determination value is less than the activation current value; and
determining that an abnormality has occurred in the liquid flow path and issuing a warning in a case where the determination value is equal to or greater than the activation current value.

5. The abnormality detection method according to claim 1, wherein
a determination time point is a time point after a pressure of the liquid flow path is stabilized, and
the abnormality detection method further comprises:
setting a start time point of the operation time region before the determination time point; and
setting an end time point of the operation time region to be later than the determination time point by a time difference between the determination time point and the start time point.

6. A liquid passage system comprising:
a liquid flow path through which a liquid flows, the liquid being supplied to a liquid ejection head configured to perform recording by ejecting the liquid onto a medium or the liquid being discharged from the liquid ejection head;
a liquid pump provided in the liquid flow path;
a driving motor configured to drive the liquid pump;
a measurement section configured to measure a current flowing through the driving motor and output a current value; and
a control section, wherein
the control section
sets, as an activation current value, a maximum value among a plurality of current values output by the measurement section in an activation time region and determines presence or absence of an abnormality of the liquid pump depending on whether or not the activation current value is included in a reference range, and
sets a determination value by performing arithmetic processing on a plurality of current values output by the measurement section in an operation time region after the activation time region and determines presence or absence of an abnormality in the liquid flow path by comparing the activation current value with the determination value.

7. A recording apparatus comprising:
a liquid ejection head configured to perform recording by ejecting a liquid onto a medium;
a liquid flow path through which the liquid flows;
a liquid pump provided in the liquid flow path;
a driving motor configured to drive the liquid pump;
a measurement section configured to measure a current flowing through the driving motor and output a current value; and
a control section, wherein
the control section
sets, as an activation current value, a maximum value among a plurality of current values output by the measurement section in an activation time region and determines presence or absence of an abnormality of the liquid pump depending on whether or not the activation current value is included in a reference range, and
sets a determination value by performing arithmetic processing on a plurality of current values output by the measurement section in an operation time region after the activation time region and determines presence or absence of an abnormality in the liquid flow path by comparing the activation current value with the determination value.

8. An abnormality detection method in a recording apparatus including
a liquid ejection head configured to perform recording by ejecting a liquid onto a medium,
a liquid flow path through which the liquid flows,
a liquid pump provided in the liquid flow path,
a driving motor configured to drive the liquid pump, and
a measurement section configured to measure a current flowing through the driving motor and output a current value,
the abnormality detection method comprising:
setting, as an activation current value, the current value output by the measurement section at an initial time point;
determining presence or absence of an abnormality of the liquid pump depending on whether or not the activation current value is included in a reference range; and
determining presence or absence of an abnormality in the liquid flow path by comparing the activation current value with the current value output by the measurement section at a measurement time point later than the initial time point.

9. The abnormality detection method according to claim 8, wherein
an inclination of a linear function is obtained using the initial time point and the activation current value, and the measurement time point and the current value output by the measurement section at the measurement time point, the liquid flow path is determined to be normal in a case where the inclination is less than 0, and the liquid flow path is determined to be abnormal in a case where the inclination is equal to or greater than 0.

10. The abnormality detection method according to claim 8, wherein
the presence or the absence of the abnormality in the liquid flow path is determined by comparing a determination value obtained by averaging a plurality of current values output by the measurement section at a plurality of measurement time points with the activation current value.

11. The abnormality detection method according to claim 10, wherein
intervals of the plurality of measurement time points are driving intervals of the liquid pump.
